(19) United States
(12) Patent Application Publication
(10) Pub. No.: US 2003/0172793 A1
(43) Pub. Date: Sep. 18, 2003

(54) Saddle and pickup device for stringed instrument

(76) Inventor: Kenta Hori, Hammatsu-shi (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/387,833

(22) Filed: Mar. 14, 2003

(30) Foreign Application Priority Data
Mar. 18, 2002 (JP) 2002-073886

(51) Int. Cl. G10D 3/04

(52) U.S. Cl. 84/298

(57) ABSTRACT

A pickup device for use in a stringed instrument (e.g., an electric guitar) is constituted using a prescribed number of saddles that are installed in a bridge attached onto the body surface at a prescribed position and are arranged to adjoin together with prescribed distances therebetween in conformity with strings respectively. Each saddle comprises a base member and a string receiving member that are engaged with each other, thus controlling the height for supporting a string thereon. A piezoelectric element is included in the string receiving member to convert string vibrations into electric signals. The height is adjusted upon rotation of the string receiving member or the base member. Due to independent arrangements of piezoelectric elements inside of the saddles, it is possible to effectively reduce effects of interference between sounds of strings.

### BACKGROUND OF THE INVENTION

1. Field of the Invention

This invention relates to saddles and pickup devices for stringed instruments such as electric guitars and acoustic guitars.

2. Description of the Related Art

Conventionally, stringed instruments such as electric guitars and acoustic guitars have bridges (or saddles) and/or pickup devices that convert vibrations of strings into electric signals. That is, electric guitars have pickup devices that convert vibrations of saddles for supporting strings to electric signals. Examples of pickup devices are shown in FIGS. 4 and 5.

A pickup device 50 shown in FIG. 4 is constituted by a bridge 51, a saddle 52, and a piezoelectric component 53. Specifically, the bridge 51 is an upright piece of wood attached onto the surface of a body (or a soundboard) of an electric stringed instrument (not shown); the saddle 52 is fixed into an elongated channel 51A of the bridge 51; and the piezoelectric component 53 is arranged beneath the saddle 52. A pickup device 55 shown in FIG. 5 is complicated in constitution compared with the aforementioned constitution of the pickup device 50 and is characterized in that the saddle 52 is fixed to the bridge 51 by means of a spacer 56 that is inserted into the elongated channel 51A of the bridge 51. Specifically, the spacer 56 is inserted into the elongated channel 51A of the bridge 51 and is firmly fixed to the surface of a body of an electric stringed instrument via two screws 57, which are screwed into prescribed positions on both ends of the spacer 56. When an operator (e.g., a user or a player) plays an electric stringed instrument, vibrations of strings are transmitted to the piezoelectric component 53 via the saddle 52, so that the piezoelectric component 53 converts vibrations to electric signals.

In both the aforementioned pickup devices 50 and 55, all the strings are supported by a single saddle 52, so that the piezoelectric component 53 collectively converts vibrations of all strings into electric signals. For this reason, sounds of different strings may interfere with each other at the saddle 52 and the piezoelectric component 53. This may cause difficulty in producing a relatively broad range of tone colors in an electric stringed instrument.

In the case of the pickup device 50 of FIG. 4, for example, it may be strictly required that the saddle 52 be firmly fixed to the bridge 51 in order to avoid occurrence of positional deviations of the saddle 52 due to vibrations of strings. Therefore, in order to adjust heights of strings stretched over the saddle 52, it is required to perform some processing on the bridge 51 and the saddle 52, which may cause troublesome operation for an operator (e.g., a worker).

In the case of the pickup device 55 of FIG. 5, the spacer 56 is fixed to the surface of a body of an electric stringed instrument via screws 57. This causes unwanted reduction of vibration or resonation of the body of an electric stringed instrument, which may deteriorate sound quality. The pickup device 55 is designed to allow collective adjustment of heights of strings stretched over the saddle 52. However, it does not allow independent adjustments of heights of strings.

The conventional pickup devices are not necessarily limited to the aforementioned pickup devices 50 and 55; therefore, it is possible to provide other types of pickup devices, an example of which is shown in FIG. 6. That is, a pickup device 60 shown in FIG. 6 comprises six saddles 61 which are arranged to adjoin each other and over which six strings are stretched independently, wherein piezoelectric elements 62 are independently arranged beneath the saddles 61.

In the aforementioned pickup device 60 shown in FIG. 6, however, the piezoelectric elements 62 may be influenced by vibrations of adjoining saddles 61, which cause difficulties in avoiding interference of sounds of strings. In addition, the piezoelectric elements 62 are respectively attached to lower surfaces of the saddles 61 via relatively small contact areas therebetween. This causes another problem in that the piezoelectric elements 62 may be easily detached from the saddles 61.

### SUMMARY OF THE INVENTION

It is an object of the invention to provide a saddle and a pickup device for a stringed instrument in which effects of interference of sounds of strings can be effectively reduced, and strings can be easily adjusted in heights over a bridge.

A pickup device of this invention for use in a stringed instrument (e.g., an electric guitar) comprises a bridge, saddles, and piezoelectric elements. A prescribed number of saddles each having a simple and compact structure are arranged to adjoin together with prescribed distances therebetween in conformity with strings of an electric stringed instrument and are embedded in holes of the bridge, which is attached onto the body surface. Each of the saddles is constituted by a base member and a string receiving member, which are combined together with a height adjusting structure therebetween. The string receiving member has a slot for receiving a string thereon, and it includes a piezoelectric element for converting vibration of the string to electric signals. The height adjusting structure is realized by an engagement between the string receiving member and the base member that is arranged in the hole of the bridge. Specifically, the external thread portion of the base member engages with the internal thread portion of the string receiving member, so that the height of the saddle for supporting the string can be easily adjusted by rotating the string receiving member or the base member.

Due to the provision of piezoelectric elements independently arranged inside of the string receiving members for receiving strings respectively, it is possible to effectively reduce effects of interference between sounds of strings of the electric stringed instrument.

### BRIEF DESCRIPTION OF THE DRAWINGS

These and other objects, aspects, and embodiments of the present invention will be described in more detail with reference to the following drawings, in which:

FIG. 1 is a perspective view showing a pickup device in accordance with a preferred embodiment of the invention;

FIG. 2 is an enlarged cross sectional view taken along line A-A in FIG. 1;

FIG. 3 is an exploded cross sectional view showing an assembly of the pickup device;

FIG. 4 is an exploded perspective view showing an example of a pickup device;

FIG. 5 is an exploded perspective view showing another example of a pickup device; and

FIG. 6 is a perspective view showing a further example of a pickup device.

### DESCRIPTION OF THE PREFERRED EMBODIMENT

This invention will be described in further detail by way of examples with reference to the accompanying drawings.

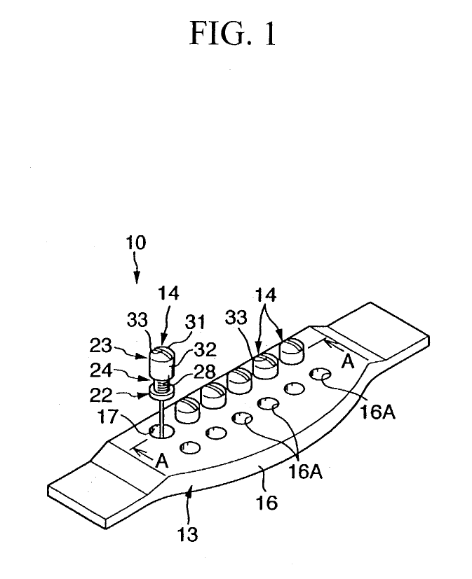

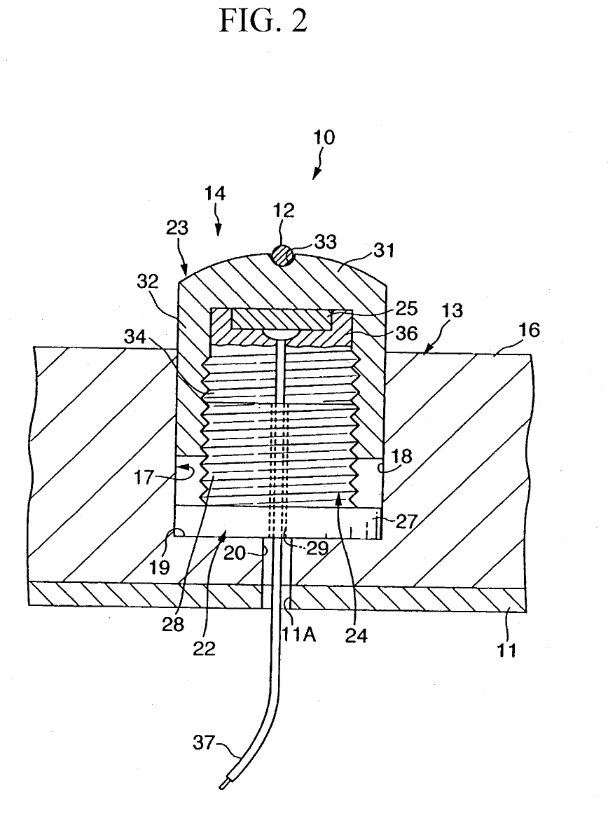

FIG. 1 is a perspective view showing a pickup device in accordance with the preferred embodiment of the invention. FIG. 2 is an enlarged cross sectional view taken along line A-A in FIG. 1. That is, a pickup device 10 is attached to a surface of a body (hereinafter, referred to as a body surface 11) of a stringed instrument such as an electric guitar and an acoustic guitar (see FIG. 2), wherein one ends of strings 12 (e.g., six strings) are securely held by the pickup device 10. The pickup device 10 is constituted by a bridge 13 that is arranged at a prescribed position of the body surface 11, and six saddles 14 installed in the bridge 13.

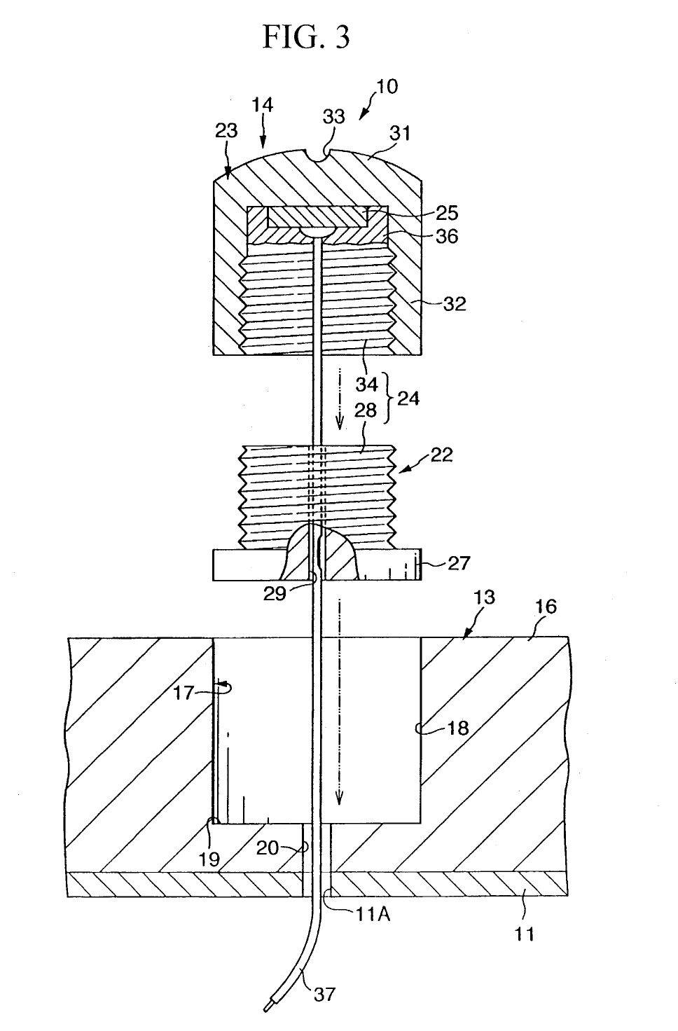

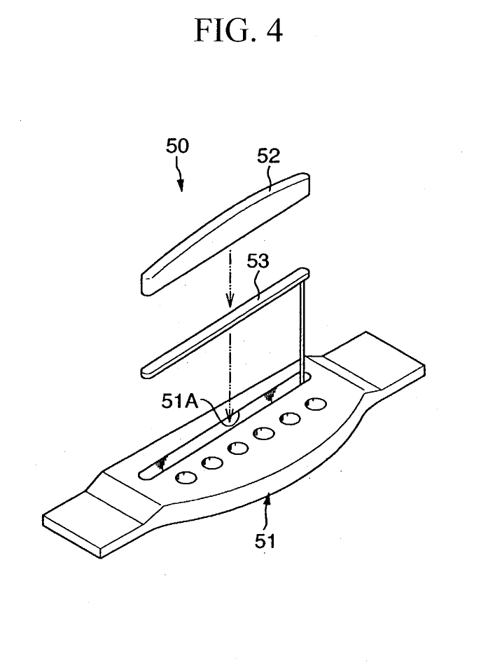

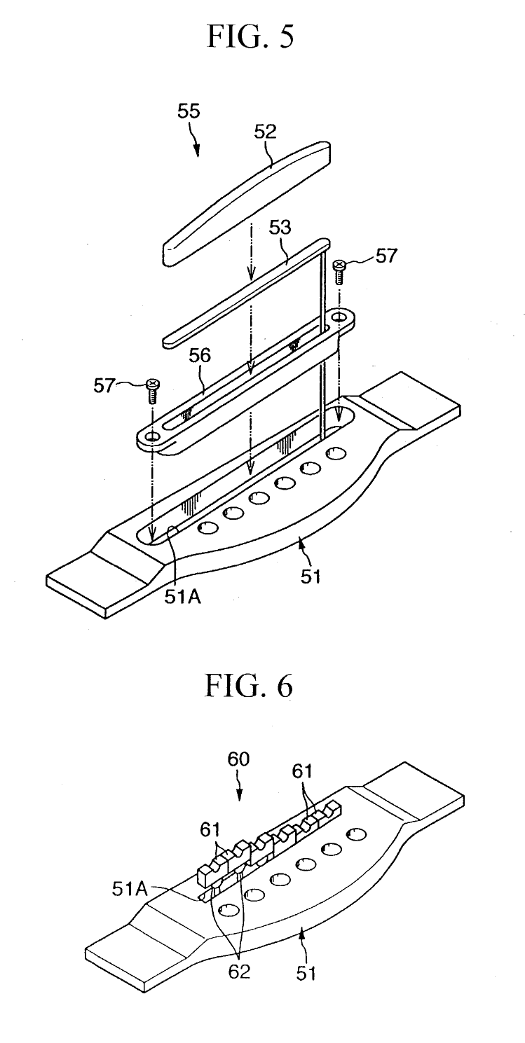

The bridge 13 is attached onto the body surface 11 of an electric stringed instrument, for example. Specifically, the bridge 13 comprises a bridge body 16 corresponding to a piece of wood roughly having an elongated rectangular shape, which is elongated in a direction substantially perpendicular to prescribed directions in which the strings 12 are stretched, in other words, which is elongated substantially transverse to the strings 12 along the body surface 11. In addition, the bridge body 16 has six holes 17 that are formed at prescribed positions in conformity with the six strings 12 that are stretched over the bridge 13, wherein six saddles 14 are respectively held in the six holes 17 of the bridge body 16. As shown in FIG. 3, each of the holes 17 has a difference in diameter and comprises a large-diameter portion 18 and a small-diameter portion 20, wherein the large-diameter portion 17 is opened on the upper surface of the bridge body 16, and the small-diameter portion 20 is communicated with the large-diameter portion 18 via a (step) difference 19. The six holes 17 are arranged to adjoin together with prescribed distances therebetween in conformity with spaced arrangements of the six strings 12, which are stretched over the bridge 13 Furthermore, six pin holes 16A (see FIG. 1) into which pins (not shown) are respectively inserted are formed at prescribed positions on the bridge body 16 in proximity to the six holes 17. That is, one ends of the strings 12 are respectively held in positions using the aforementioned pins.

As described above, the six saddles 14 are arranged on the bridge 13 in conformity with the six strings 12, which are supported by the six saddles 14 under tension, respectively. As shown in FIG. 3, each saddle 14 is constituted by a base member 22, a string receiving member 23, a height adjusting structure 24, and a piezoelectric element 25. Herein, the base member 22 is arranged on the difference 19 of the hole 17 of the bridge body 16 and is combined together with the string receiving member 23. The height adjusting member 24 is arranged between the base member 22 and the string receiving member 23. The piezoelectric element 25 is arranged inside of the string receiving member 23. Both the base member 22 and the string receiving member 23 are made of conductive metal materials such as brass and copper materials, which allow the string 12, base member 22, and string receiving member 23 to be grounded, thus avoiding the occurrence of noise.

The base member 22 is constituted by a disk portion 27, an external thread portion 28, and a through hole 29. That is, the disk portion 27 has approximately the same diameter of the large-diameter portion of the hole 17 and is arranged on the difference 19 of the hole 17. The external thread portion 28 is extended upwardly from the upper surface of the disk portion 27 and is arranged concentrically on the disk portion 27. The through hole 29 is formed to penetrate through the axial center of the disk portion 27 and the external thread portion 28.

The string receiving member 23 is constituted by a top portion 31 and an external case 32, wherein the upper surface of the top portion 31 is curved like a hemisphere, and the external case 32 having substantially the same outer diameter of the disk portion 27 is extended downwardly from the outer periphery of the top portion 31 and is opened downwards. A slot 33 engaging with the string 12 is formed substantially at the center of the upper surface of the top portion 31 and is elongated to conform with a part of the string 12 that is stretched over the bridge 13 under tension in a prescribed direction (i.e., a vertical direction of FIG. 2). Therefore, the string receiving member 23 can securely hold the string 12 when stretched, thus avoiding dropout of the string 12 therefrom. An internal thread portion 34 is formed on the interior circumferential wall of the external case 32. Therefore, the aforementioned height adjusting structure 24 is realized by the aforementioned external thread portion 28 and the internal thread portion 34, which are engaged with each other.

The piezoelectric element 25 is adhered to the backside of the top portion 31 in proximity to the string 12, which is engaged with the slot 33 of the top portion 31. Therefore, the piezoelectric element 25 is capable of converting vibration of the string 12, which is transmitted thereto via the top portion 31 of the string receiving member 23, to electric signals when an operator (i.e., a user or a player) plays an electric stringed instrument. In addition, a filler material 36 is arranged outside of the piezoelectric element 25 to fill the space inside of the external case 32. That is, the piezoelectric element 25 can be firmly attached to the backside of the top portion 31 of the string receiving member 23. Furthermore, a shielded line 37 allowing transmission of electric signals of the piezoelectric element 25 is connected to the lower surface of the piezoelectric element 25 that is arranged inside of the external case 32 of the string receiving member 23. The shielded line 37 is extended to penetrate through the through hole 29 of the base member 22 arranged inside of the large-diameter portion 18 of the hole 17, the small-diameter portion 20, and a hole 11A of the body surface 11 in turn; then, it is connected with switches, an amplifier, etc. Therefore, upon manipulation of switches, vibration of a specific string can be selectively converted into electric signals. Incidentally, a part of the shielded line 37 inside of the through hole 29 of the base member 22 is partially stripped to remove a shield film therefrom and is connected with the interior wall of the through hole 29, thus being grounded.

In the aforementioned pickup device 10, in order to adjust the height of the string 12 that is stretched under tension over the saddle 14 of the bridge 13 on the body surface 11 of an electric stringed instrument, an operator loosens the string 12 and then rotates the string receiving member 23 in the circumferential direction of the external case 32 in such a way that the direction of the slot 33 substantially matches the extending direction of the string 12. That is, due to the height adjusting structure 24 realized by the engagement of the external thread portion 28 and the internal thread portion 34, the string receiving member 23 is moved upwards or downwards, so that the height of the string 12 supported on the saddle 14 is being automatically adjusted.

When an operator plays an electric stringed instrument, vibration of the string 12 is transmitted to the piezoelectric element 25 that is located just under the string 12 via the top portion 31 of the string receiving member 23, so that it is converted into electric signals. At the same time, both the bridge 13 and the body surface 11 are simultaneously vibrated together with the saddle 14 on which the string 12 is vibrating. Therefore, sound vibrations may be transmitted over the entirety of the body of the electric stringed instrument.

The present embodiment is designed in such a way that the saddles 14 are arranged to adjoin together on the bridge 13 with prescribed distances therebetween. This may considerably reduce effects of interference between sounds produced by the strings 12, so that the piezoelectric elements 25 can convert vibrations of the strings independently into electric signals. In addition, the saddles 14 are respectively arranged for the strings 12 to be independently adjusted in heights with ease.

Furthermore, the slots 33 are formed on the upper surfaces of the top portions 31 of the string receiving members 23 for respectively receiving the strings 12. In order to adjust the height of the string 12, the string receiving member 23 is rotated in a circumferential direction by 180° in such a way that the direction of the slot 33 substantially matches the extending direction of the string 12. That is, it is possible for an operator to adjust the height of the string receiving member 23 by approximately a half pitch in engagement between the external thread portion 28 and the internal thread portion 34. This may allow fine adjustment of the height of the string 12, which may be referred to as digital adjustment for adjusting the height in a step-by-step manner.

Incidentally, the height adjusting structure 24 is not necessarily limited to the aforementioned engagement of the external thread portion 28 and the internal thread portion 34. For example, it is possible to modify the relationship between the base member 22 and the string receiving member 23 in such a way that an internal thread portion is arranged in the base member 22 while an external thread portion is arranged in the string receiving member 23.

The present embodiment is designed in such a way that the base member 22 is attached onto the difference 19 in the hole 17 of the bridge body 16. This invention is not necessarily limited to the present embodiment; hence, the base member 22 can be merely mounted on the difference 19 in the hole 17 of the bridge body 16. This may allow an operator to pull out all members of the saddle 14 from the large-diameter portion 18 of the hole 17 of the bridge body 16, so that the operator rotates the base member 22 and the string receiving member 23 to be mutually adjusted in engagement and then the operator puts back them into the large-diameter portion 18 of the hole 17. That is, it is possible to realize analog adjustment for adjusting the height of the string 12 in a stepless or continuous manner.

Of course, it is possible to provide the pickup device with other modifications or design changes, which allow adjustment of the height of the string 12 in response to rotation of the string receiving member 23.

As described heretofore, this invention has a variety of effects and technical features, which will be described below.

(1) A pickup device of this invention for use in a stringed instrument such as an electric guitar provides a height adjusting structure for adjusting the height of a string in response to rotation of a string receiving member. That is, this invention can be easily realized without substantially changing the constitution of a bridge of a stringed instrument.

(2) That is, a prescribed number of saddles for respectively supporting strings of a stringed instrument are arranged to adjoin together in the bridge with prescribed distances therebetween. Therefore, it is possible to considerably reduce effects of interference between sounds of strings, vibrations of which are picked up by piezoelectric elements arranged beneath strings. This may contribute to noticeable improvement of sound quality of a stringed instrument. In addition, when piezoelectric elements are connected with switches, for example, it is possible to selectively output sound of a specific string.

(3) The saddle is constituted by a base member and a string receiving member, which are combined together and are partially embedded in a hole of the bridge in conformity with a string. Herein, the height adjusting structure is realized by engagement of a first thread portion of the base member and a second thread portion of the string receiving member. That is, the height of the saddle can be easily adjusted by rotating the string receiving member. Therefore, even when strings are arranged to adjoin together with relatively small distances therebetween, their heights can be easily and reliably adjusted by use of the saddles each having a simple and compact structure. In addition, since the base member of the saddle is brought into contact with the bridge, it is possible to actualize effective transmission or propagation of vibration of a string to the bridge.

(4) The string receiving member comprises a top portion and an external case, wherein the external case is extended downwards from the top portion and is opened downwards. A piezoelectric element is attached to the backside of the top portion of the string receiving member, while a string is engaged with a slot formed on the upper surface of the top portion of the string receiving member. Therefore, it is possible to approach the string very close to the piezoelectric element arranged inside of the string receiving member. That is, it is possible to noticeably improve response of the piezoelectric element picking up vibration of the string.

(5) The string is securely received by the slot formed on the upper surface of the top portion of the string receiving member. Therefore, it is possible to establish a prescribed positioning accurately with respect to the string. In addition, the height of the string can be easily adjusted in a step-by-step manner upon rotation of the string receiving member by 180°. Alternatively, the height of the string can be adjusted in a stepless or continuous manner upon rotation of the base member without substantially rotating the string receiving member whose slot engages with the string.

As this invention may be embodied in several forms without departing from the spirit or essential characteristics thereof, the present embodiment is therefore illustrative and not restrictive, since the scope of the invention is defined by the appended claims rather than by the description preceding them, and all changes that fall within metes and bounds of the claims, or equivalents of such metes and bounds are therefore intended to be embraced by the claims.

What is claimed is:

1. A saddle attached to a bridge of a stringed instrument, comprising:
a base member installed in the bridge; and
a string receiving member for receiving a string thereon,
wherein the string receiving member is engaged with the base member to realize a height adjusting structure therebetween, so that a height for supporting the string is adjusted upon rotation of the string receiving member or the base member.

2. A saddle according to claim 1, wherein the base member has a first thread portion that is engaged with a second thread portion of the string receiving member.

3. A saddle according to claim 1 or 2, wherein the string receiving member comprises a top portion for receiving the string thereon and an external case that is formed downwardly from the top portion and is opened downwards, so that a piezoelectric element is attached to a backside of the top portion inside of the external case.

4. A saddle according to claim 1 or 2, wherein the string receiving member comprises a top portion having a slot for receiving the string thereon and an external case that is formed downwardly from the top portion and is opened downwards, so that a piezoelectric element is attached to a backside of the top portion inside of the external case.

5. A pickup device for use in a stringed instrument, comprising:
a bridge attached onto a body surface of the stringed instrument at a prescribed position; and
a plurality of saddles that are installed in the bridge and are arranged to adjoin together with prescribed distances therebetween in conformity with strings respectively,
wherein each of the saddles comprises a base member and a string receiving member that are engaged with each other, so that a height for supporting the string is adjusted upon rotation of the string receiving member or the base member.

6. A pickup device according to claim 5, wherein the base member has a first thread portion that is engaged with a second thread portion of the string receiving member.

7. A pickup device according to claim 5 or 6, wherein the string receiving member comprises a top portion for receiving the string thereon and an external case that is formed downwardly from the top portion and is opened downwards, so that a piezoelectric element is attached to a backside of the top portion inside of the external case.

8. A pickup device according to claim 5 or 6, wherein the string receiving member comprises a top portion having a slot for receiving the string thereon and an external case that is formed downwardly from the top portion and is opened downwards, so that a piezoelectric element is attached to a backside of the top portion inside of the external case.
